(19) United States
(12) Patent Application Publication
(10) Pub. No.: US 2026/0225313 A1
(43) Pub. Date: Aug. 6, 2026

(54) METHOD FOR PRODUCING GRAPHITISED FORMED PARTS BY MEANS OF 3D PRINTING

(71) Applicant: Nippon Kornmeyer Carbon Group GmbH, Windhagen (DE)

(72) Inventors: David KLEIN, Hennef (Sieg) (DE); Michael GERADS, Bonn (DE)

(73) Assignee: Nippon Kornmeyer Carbon Group GmbH, Windhagen (DE)

(21) Appl. No.: 19/149,450

(22) PCT Filed: Jan. 24, 2023
(86) PCT No.: PCT/EP2023/051628

§ 371 Date: Jul. 18, 2025

(51) Int. Cl. B29C 64/295; B29C 64/118; B29C 64/371; B29C 64/40; B33Y 10/00; B33Y 40/20

(52) U.S. Cl. CPC B29C 64/295; B29C 64/118; B29C 64/371; B29C 64/40; B33Y 10/00; B33Y 40/20

(57) ABSTRACT

A method produces graphitised formed parts by 3D printing from conventional filaments made of a plastic. It allows producing graphitised 3D formed parts, or another three-dimensional structure made of a thermoplastic material by 3D printing. This is achieved by melting a filament made of a meltable and curable plastic and applying same layer by layer by the 3D printer until the desired structure has been created, stabilising the 3D structure printed from the material of the filament by way of temperature treatment to chemically or crystallographically change the plastic in that pre-stabilisation at ~180° C. is carried out over a longer period, followed by a stabilisation step at ~250° C. until the printed 3D structure is sufficiently dimensionally stable as a stabilised structure and a carbonising or graphitising of the 3D structure, to produce the graphitised structure.

### CROSS-REFERENCE TO RELATED APPLICATION

This application is a national stage application, filed under 35 U.S.C. § 371, of International Patent Application PCT/EP2023/051628.

### TECHNICAL FIELD

The disclosure relates to a method for producing graphitized shaped parts by 3D printing with filaments composed of a fusible plastic.

### BACKGROUND

WO 2018/196965 A1 describes a method for producing ceramic objects by 3D printing.

To this end, a carbon-or graphite-containing precursor material is mixed with an inorganic component, and a carbide-based ceramic object is produced by thermal treatment with a 3D printer. The inorganic component is a metal, such as silicon, titanium, tungsten, or a metal oxide.

The precursor material further contains carbon black or graphite powder, and also a polymer, such as polyacrylonitrile.

The precursor material prepared in this manner is used to fabricate the desired object layer by layer using 3D printing technology, specifically fused deposition modeling, with a 3D printer.

After it has been printed, the object is stabilized in air at a temperature between approx. 160° C. and approx. 250° C., followed by a carbonization process at a temperature between 1000° C. and 1500° C.

Furthermore, WO 01/98207 A1 describes a shapable mixture and the use thereof.

The shapable raw material comprises powdered silicon, and a carbon precursor comprising a water-soluble, crosslinkable and heat-curable synthetic resin, and a powdered silicon filler material, and a water-soluble thermoplastic binder.

The method, by means of which honeycomb structures can be produced, comprises mixing the materials to produce a shapable material mixture followed by
forming a green body, which is preferably effected by extruding,
drying and curing the green body.

This is followed by heating the green body in a nitrogen atmosphere up to a temperature sufficient to carbonize the resin and at a temperature sufficient to convert the green body into porous silicon carbide, preferably sintering said green body at above 1400° C.

### SUMMARY

It is an object of the disclosure to provide a substantially simplified method in relation to the prior art for producing graphitized shaped parts, for example in the form of a honeycomb structure or any other three-dimensional structure, from a thermoplastic by 3D printing for use as a carrier for a catalyst, a filter or the like, or some other component.

The object is achieved by
printing a 3D structure with a 3D printer using a fusible and curable filament composed of plastic by fusing the filament and applying it layer by layer until the desired structure is created,
stabilizing the printed 3D structure consisting of the material of the filament by a temperature treatment to chemically or crystallographically alter the plastic, through
prestabilization of the 3D structure at 150° C.-~180° C. for a specified period, followed
by a stabilization step at ~250° C.±20° C. until the 3D structure is sufficiently dimensionally stable.

It has been found that, surprisingly, it is possible to produce a 3D article, for example a honeycomb structure, a figure or the like, by printing with a 3D printer using a plastic filament without any other admixtures and then directly convert it into a graphitized shaped part while maintaining the printed structure by a high-temperature treatment which follows a two-stage stabilization treatment.

In a first development of the invention, the fusible filament consists of a thermoplastic, such as ABS (acrylonitrile-butadiene-styrene copolymer) or PVA/BVOH (polyvinyl alcohol) or BVOH (butenediol-vinyl alcohol copolymer).

In a further embodiment of the invention, the printed 3D structure is heated to the temperature for prestabilization and the temperature for stabilization at a heating ramp of 0.2° C./min to 1° C./min in each case.

Lastly, in one development of the invention, the prestabilization and the stabilization of the printed 3D structure, after the respectively specified temperature has been reached and is kept constant, are effected for a number of hours to a number of days depending on the size of the 3D structure, preference being given to a temperature of 180° C. for prestabilization in the interests of quickening this process.

It is important for stabilization that, in each case, the highest possible temperature at which melting or severe deformation does not occur is tailored to the chosen filament material, such that stabilization can be quickened altogether.

Furthermore, it is advantageous if the printed 3D structure is stabilized by a support device during prestabilization and stabilization in order to avoid deformation, especially in the case of large parts.

A support device that may advantageously be used for the printed 3D structure is a temperature-stable material, such as metal or graphite, though it is also possible to use a shaped part produced by this method as a support.

Alternatively, the printed 3D structure may be embedded in a temperature-stable powder, such as graphite dust or fine-grained cooking salt, as a support device.

In one development of the invention, the stabilized 3D structure is carbonized at a high temperature and lastly graphitized, which is effected at a temperature of >1800° C., preferably at >2000° C.

It will be understood that graphitization must be effected either under reduced pressure or under an inert gas, such as argon, krypton, xenon or nitrogen, in order to prevent combustion of carbon.

During graphitization, a cleaning process to remove extrinsic elements, such as metals, may be initiated at the same time by supplying the furnace atmosphere with a halogen gas, such as chlorine.

In a further development of the invention, the three-dimensional structure is coated with a pyrolytic carbon after it has been graphitized, in order to seal the structure and to be able to use it as a carrier for a catalyst, to make it more stable, or to be able to use it as a carrier in the form of a skeleton, for example in order to be able to use the skeleton (e.g., honeycomb structure), through suitable coating thereof, as a carrier for a catalyst.

Furthermore, the graphitized structure may be coated with silicon carbide, silicon nitrite or tantalum carbide or converted into silicon carbide or tantalum carbide.

The graphitized 3D structure may also be impregnated with pitch or a resin in order to achieve compaction.

In a particular embodiment of the invention, a support or supporting structure, or a scaffold, is first printed and stabilized on a suitable base in a first step and said support is subsequently then used as a carrier, prop or rest for the 3D structure to be printed in a second step.

So that the printed 3D structure supported by the support or supporting structure can be easily detached or lifted therefrom or removed therefrom, the printing of the support or supporting structure may be followed by applying a release agent thereto at least in the regions that come into contact with the 3D structure when it is subsequently printed.

Alternatively, the support or supporting structure may also be printed at the same time as the 3D structure.

For example, what may be printed are a crucible or pot and a supporting structure in the form of a honeycomb structure on the outside and/or inside in the crucible or pot, thus producing an altogether more stable structure. Finally, the supporting structure can be mechanically removed after graphitization. This may be done by scraping the crucible or pot.

The invention shall now be more particularly elucidated with reference to a working example.

### BRIEF DESCRIPTION OF THE DRAWINGS

FIG. 1: a schematic illustration of a 3D printer;

FIG. 2a: a three-dimensional structure in the form of a honeycomb structure after printing;

FIG. 2b: the three-dimensional structure after stabilization;

FIG. 2c: the three-dimensional structure after graphitization;

FIG. 3: examples of three-dimensional structures manufactured by the method according to the invention, for example in the form of a carrier for a catalyst or a filter, a container and a structural part (cube);

FIG. 4: a typical heat curve for prestabilization and stabilization;

FIG. 5: a further example of a 3D structure in the form of a frog;

FIG. 6a: a crucible or pot having a delicate supporting structure on the inside in the form of a honeycomb structure after printing and stabilization; and

FIG. 6b: the crucible or pot, in which the supporting structure has been mechanically removed after graphitization.

### DETAILED DESCRIPTION

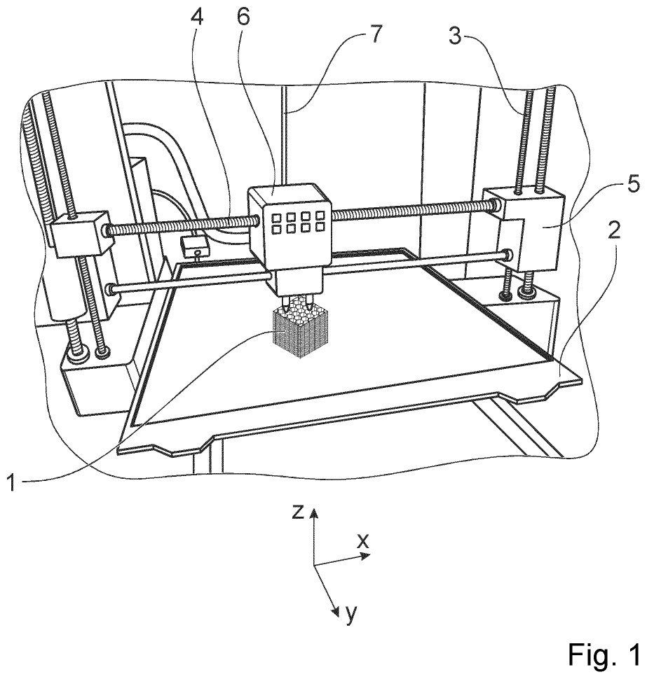

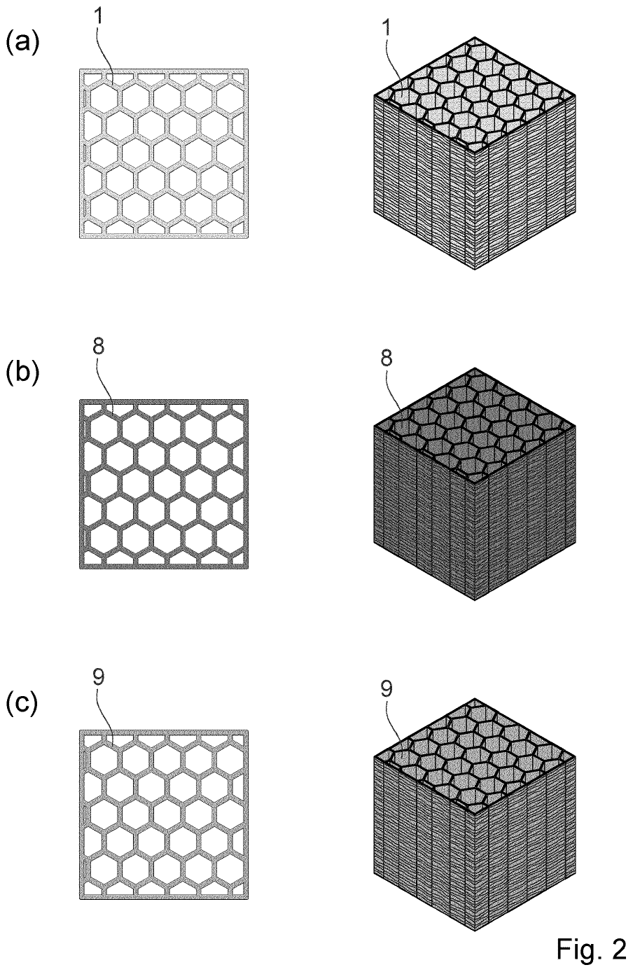

For the production of shaped parts, for example in the form of a honeycomb structure (cf. FIG. 2) or any other three-dimensional structure 1, from a fusible and curable plastic using a filament composed of thermally fusible plastic, customary 3D printers (FIG. 1) are most suitable. The filaments used may be commercially available filaments.

The 3D printer basically consists of a base plate 2 with threaded supports 3 which are spaced from each other and vertically oriented and movable in the Y-direction, i.e., forward and backward, and between which horizontal threaded bars 4 are suspended on the threaded supports 3 by means of threaded sleeves 5 for vertical movement in the Z-direction. Lastly, the threaded bars 4 bear the actual 3D print head 6, movable in the X-direction (transverse direction), for printing of the 3D structure 1 by fused deposition modeling of a filament 7 supplied to the heatable print head 6. Exact X-, Y- and Z-positioning is usually ensured by appropriately controlled stepper motors.

Using such a 3D printer of relatively simple construction together with a corresponding programmable control system, any 3D structure 1 can be realized. Examples of such 3D structures are shown in FIGS. 2, 3 and 5.

However, if 3D structures 1 produced in this way are to be graphitized after printing, there is the particular problem of the thermally fusible plastic used to print the 3D structure 1 fusing once again or at least becoming misshapen at the high temperatures of above 2000° C. necessary for graphitization. This means that the desired end product, which ultimately consists only of a graphite structure, cannot be produced in this way.

The invention proceeds from here, by first printing a three-dimensional structure 1 with a 3D printer using the filament 7 composed of a suitable plastic through fusion of the filament and application thereof layer by layer until the desired 3D structure, for example a honeycomb structure, a skeleton or a scaffold, is formed (FIG. 2a). A particularly suitable plastics material for the filament is ABS (acrylonitrile-butadiene-styrene copolymer), PVA/BVOH (polyvinyl alcohol) or butenediol-vinyl alcohol copolymer).

Also suitable is TPU (thermoplastic polyurethane), but with higher temperature-related deformation, similar to ABS.

This is followed by stabilizing the printed 3D structure 1 by a specific temperature treatment through alteration of the chemical or crystallographic structure of the plastic.

This is accomplished by prestabilization at 150° C. to ~180° C. for a relatively long period until the printed 3D structure 1 is dimensionally stable, followed by a stabilization step at 250° C.±20° C. until the 3D structure is sufficiently dimensionally stable, such that it can be transported or handled in some other way without suffering damage. Preference is given to a temperature of 180° C. for prestabilization because stabilization is quickened at this temperature without the onset of melting.

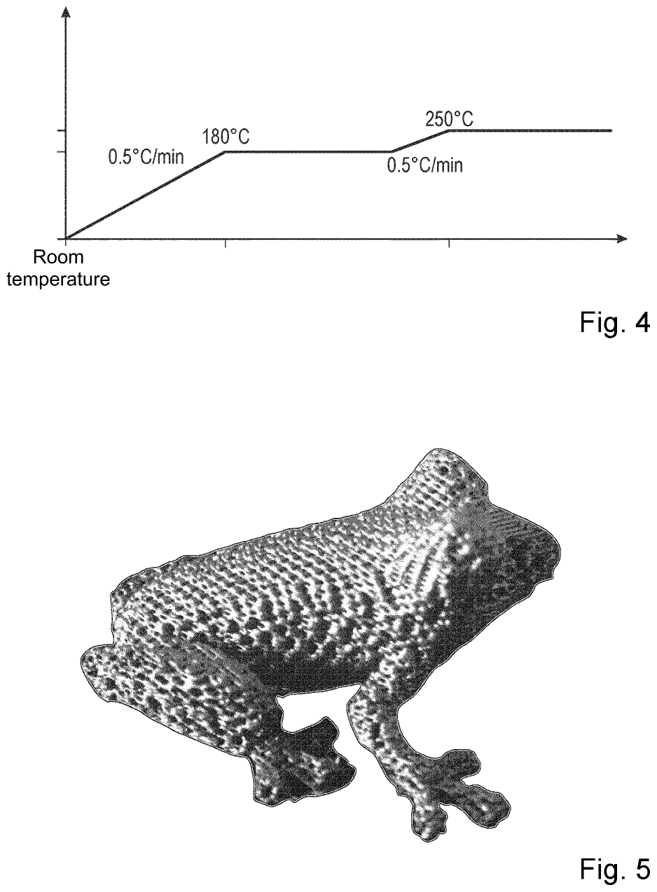

FIG. 4 shows the corresponding temperature profile for the entire stabilization process, the 3D structure being heated to the temperature for prestabilization and the temperature for stabilization at a heating ramp of 0.2 to 1° C./min, preferably at 0.5° C./min, in each case.

The actual prestabilization and stabilization of the printed 3D structure 1 is effected in a long process by keeping the respective temperature constant for a number of hours to a number of days depending on the size of the 3D structure. The result of this thermal process is a stabilized 3D structure 8, as shown in FIG. 2 by way of example.

Furthermore, it is advantageous if the 3D structure 1 is stabilized by supports, at least at critical points, during prestabilization and stabilization in order to avoid deformation. Especially relatively large printed 3D structure 1 are affected by this risk of deformation.

A possible support for the 3D structure that may be used is advantageously a scaffold composed of a temperature-stable material, such as metal or graphite, that supports the printed 3D structure 1 at multiple suitable points, for example on the outside, bottom or inside. The support used may also be a scaffold produced by this method.

It is possible to first print a support or supporting structure, or a scaffold, on a suitable base in a first step, for example by the method described, and to then use said support as a carrier, prop or rest for the 3D structure to be printed in the second step.

The support or supporting structure may also be printed at a higher or lower density than the 3D structure 1; at the least, the support or supporting structure should have sufficient mechanical strength, as is the case for example for a honeycomb structure or the like.

Furthermore, it must be ensured that the material used for printing the support cannot join or bond to that for printing the material used for the 3D structure, in order to be able to easily lift the 3D structure from the support or supporting structure after stabilization; alternatively, it must be ensured that the support or supporting structure has a sufficiently low density, such as a honeycomb structure, such that it can be easily mechanically removed from the 3D structure without damaging it.

It is also possible for the printing of the support or supporting structure to be followed by applying a release agent thereto at least in the regions that can come into contact with the 3D structure when it is subsequently printed.

Furthermore, the support or supporting structure, for example in the form of a delicate honeycomb structure, and the 3D structure may also be printed at the same time. The delicate honeycomb structure has the advantage of particularly high stability, but can be easily mechanically removed after graphitization without damaging the 3D structure.

In another alternative, the printed 3D structure 1 may be embedded in a temperature-stable powder, such as graphite dust or fine-grained cooking salt, as a support.

A disadvantage here is the relatively poor heat conduction by the powder, which is rebalanced by the already long stabilization time.

After completion of stabilization, the stabilized 3D structure 8 (FIG. 2(b)) can be graphitized at high dimensional stability under exclusion of air at a high temperature in a suitable furnace, which may be effected at a temperature of >1800° C., preferably at >2000° C.. In this process, what is effected first is carbonization of the stabilized 3D structure, i.e., conversion of the plastic into a carbon-containing structure or an amorphous carbon structure, which is ultimately converted into graphite.

It will be understood that the graphitization of the stabilized 3D structure 8 must be effected either under reduced pressure or under an inert gas, such as argon, krypton, xenon or nitrogen, in a furnace suitable for this purpose in order to avoid oxidative damage. The result is a graphitized 3D structure 9 (FIG. 2(C)).

During graphitization, a cleaning process to remove extrinsic elements, such as metals, from the graphitized 3D structure 9 may be initiated at the same time by additionally supplying the furnace atmosphere with a halogen gas, such as chlorine.

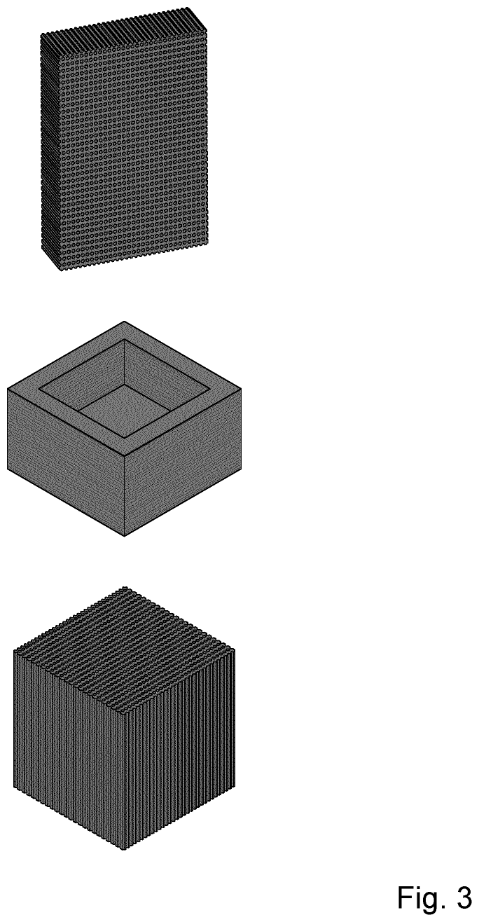

An example of a graphitized 3D structure 9 in the form of a honeycomb structure is shown in FIG. 2c. The honeycomb structure has comparatively high mechanical stability and contains particularly little material, though other 3D structures may of course also be produced as desired by the method according to the invention, cf. FIG. 3 or FIG. 5, in which the example illustrated is a frog produced by the method according to the invention.

It is also possible, after graphitization, to coat the graphitized 3D structure 9 with a pyrolytic carbon in order to seal the structure, to make it more stable, or to be able to use it as a carrier in the form of a skeleton.

Alternative coatings are also possible with silicon carbide (SiC), silicon nitride or tantalum carbide, or it is also possible to convert the graphitized 3D structure into silicon carbide or tantalum carbide by exposing the 3D structures in the furnace to gases of said materials, for example SiO or Ta₂O₅.

Furthermore, the graphitized three-dimensional structure 9 may be impregnated with pitch or a resin in order to achieve compaction, for example for filtering purposes.

Since the coating and also the impregnation are performed at high temperatures, it is necessary for the 3D structure to have been at least stabilized beforehand.

FIG. 3 shows a few application examples of 3D structures manufactured by the method according to the invention, for example in the form of a carrier for a catalyst or a filter (top), a container (middle) and a structural part, for example a cube (below).

To use the graphitized 3D structure 9 as a carrier for a catalyst, the only requirement is to coat it in a suitable coating device with the materials required for the catalyst function. Suitable for this purpose are the known coating methods such as CVD (chemical vapor deposition), PVD (physical vapor deposition), PECVD (plasma-enhanced chemical vapor deposition) or the like.

Alternatively, wet-chemical coating of the graphitized 3D structure by a sol-gel method may also be carried out in order to be able to use it as a catalyst.

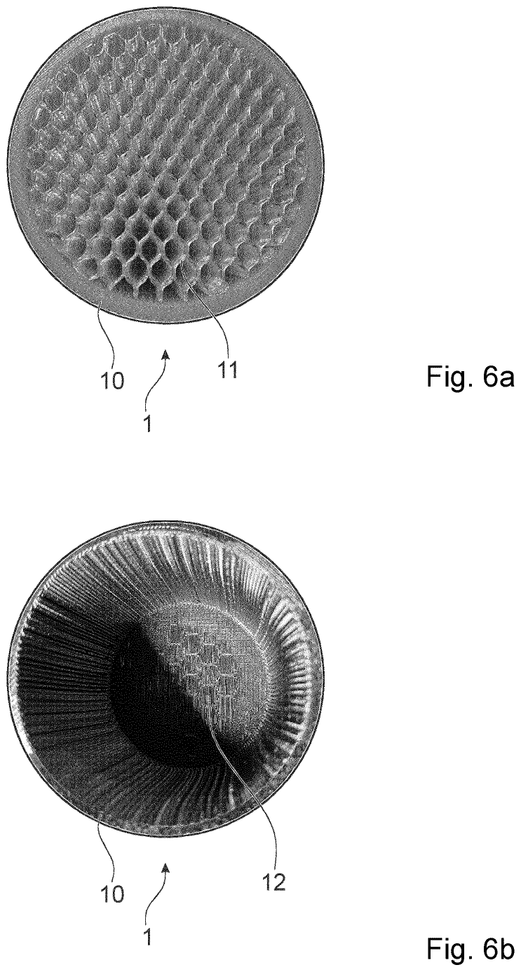

FIG. 6a shows an example of a 3D structure 1 in the form of a crucible or pot 10 and an inner supporting structure 11 in the form of a honeycomb structure in the crucible or pot, which has been printed at the same time as the crucible or pot (FIG. 6a). It will be understood that the 3D structure may also have a different shape.

The delicate supporting structure 11 can be easily mechanically removed after graphitization. This may be done by scraping the crucible or pot 10.

FIG. 6b shows the crucible or pot 10, in which the supporting structure 11 has been removed after graphitization. Traces 12 of the removed support are visible on the inner bottom of the crucible or pot 10.

### LIST OF REFERENCE SIGNS

1 printed 3D structure
2 base plate
3 threaded support
4 threaded bar
5 threaded sleeve
6 print head
7 filament
8 stabilized 3D structure
9 graphitized 3D structure
10 crucible or pot
11 supporting structure
12 traces of the removed support

1-20. (canceled)

21. A method for producing graphitized shaped parts by 3D printing, the method comprising:
forming a 3D structure with a 3D printer by melting a filament composed of a meltable and curable plastic and depositing the filament layer by layer with the 3D printer until the 3D structure is created; and
stabilizing the 3D structure by a temperature treatment to chemically or crystallographically alter the meltable and curable plastic, including prestabilizing the 3D structure at 150° C. to 180° C., followed by stabilizing the 3D structure at 250° C.±20° C. until the 3D structure is dimensionally stable; and
graphitizing the 3D structure, after stabilizing, at a temperature of >1800° C.

22. The method as claimed in claim 21,
wherein the meltable and curable plastic is acrylonitrile-butadiene-styrene copolymer (ABS), polyvinyl alcohol (PVA), butenediol vinyl alcohol copolymer (BVOH), or thermoplastic polyurethane (TPU).

23. The method as claimed in claim 21, wherein heating the 3D structure during prestabilizing and stabilizing is performed with a heating ramp of 0.2-1.0° C./min.

24. The method as claimed in claim 21, wherein the prestabilizing and the stabilizing of the 3D structure, after a respective temperature has been reached and is kept constant, is performed over a period of time depending on a size of the 3D structure.

25. The method as claimed in claim 21, further comprising
supporting the 3D structure by a support device during prestabilizing and stabilizing to prevent deformation.

26. The method as claimed in claim 25, wherein the support device is made of metal or graphite.

27. The method as claimed in claim 21, further comprising
embedding the 3D structure in a temperature-stable powder.

28. The method as claimed in claim 27,
wherein the temperature-stable powder is graphite dust or fine-grained cooking salt.

29. The method as claimed in claim 21,
wherein the graphitizing is performed under reduced pressure, or under an inert gas selected from the group consisting of argon, krypton, xenon, and nitrogen.

30. The method as claimed in claim 21, further comprising
supplying a halogen gas in a furnace atmosphere during graphitizing the 3D structure.

31. The method as claimed in claim 30, wherein the halogen gas is chlorine.

32. The method as claimed in claim 21, further comprising
coating the 3D structure after graphitizing with a pyrolytic carbon.

33. The method as claimed in claim 21, further comprising
coating the 3D structure after graphitizing with silicon carbide, silicon nitrite, or tantalum carbide.

34. The method as claimed in claim 21, further comprising
converting the 3D structure after graphitizing into silicon carbide or tantalum carbide.

35. The method as claimed in claim 21, further comprising
impregnating the 3D structure after graphitizing with pitch or a resin.

36. The method as claimed in claim 21, further comprising:
printing and stabilizing a support or a supporting structure or a scaffold on a base in a first step, and
using the support or the supporting structure or the scaffold as a carrier, prop, or rest for the 3D structure while forming the 3D structure.

37. The method as claimed in claim 36, further comprising
applying a release agent to the support or the supporting structure or the scaffold at least in regions that come into contact with the 3D structure.

38. The method as claimed in claim 21, further comprising printing a support or a supporting structure simultaneously while forming the 3D structure.

39. The method as claimed in claim 38,
wherein the 3D structure is a crucible or a pot, and
wherein the method further comprises
graphitizing the 3D structure and
thereafter removing the support or the supporting structure.
